(19) United States
(12) Patent Application Publication
(10) Pub. No.: US 2010/0284873 A1
(43) Pub. Date: Nov. 11, 2010

(54) REMOVING A HEAVY METAL FROM A COMBUSTION GAS

(75) Inventor: Michael Cooper, Denver, NC (US)

Correspondence Address: DICKINSON WRIGHT PLLC, 1875 Eye Street, NW, Suite 1200, WASHINGTON, DC, 20006, US

(73) Assignee: COALOGIX TECH INC., Charlotte, NC (US)

(21) Appl. No.: 12/776,084

(22) Filed: May 7, 2010

Related U.S. Application Data
(60) Provisional application No. 61/176,759, filed on May 8, 2009.

(51) Int. Cl. B01D 53/64; C09K 3/00

(52) U.S. Cl. 423/215.5; 252/184

(57) ABSTRACT

This invention is directed to a process and chemical composition effective in removing heavy metal from combustion gas. The process and chemical composition are particularly effective in removing undesirable heavy metal from combustion gases that are formed from the combustion of coal. The chemical composition that is used is an aqueous composition of at least one alkali metal sulfide, and at least one alkali metal or alkaline earth metal buffer in amounts that are effective in removing at least a majority of the heavy metal from the combustion gas.

### CROSS-REFERENCE TO RELATED APPLICATIONS

This application claims benefit of the filing date of copending nonprovisional application, U.S. Application No. 61/176,759, the contents of which are fully incorporated herein by reference.

### FIELD OF THE INVENTION

This invention is directed to a process for removing heavy metal from a combustion gas and a composition effective in removing the heavy metal. In particular, the process and composition are particularly effective in removing heavy metal from combustion gas formed from the combustion of coal.

### BACKGROUND OF THE INVENTION

For reasons primarily related to cost and energy content the coal fired power generation industry is increasingly turning to the use of high sulfur coal as a primary fuel source. As a by-product of combustion these fuels generate significant amounts of sulfur dioxide which can cause environmental problems, and must therefore be removed from the flue gas before that gas exits the stack. One type of technology used for the removal of SO₂ from flue gas within the power generation industry is a flue gas de-sulfurization unit, or FGD; commonly referred to as a “scrubber.”

Basically, a scrubber is a large vessel, for example, 750,000 gallons for a 900 MW power plant, in which flue gas is exposed to a spray of water combined with solid reagent that reacts with the SO₂ in the flue gas to form a solid and relatively benign material. One type of scrubber reagent is calcium carbonate (CaCO₃), which on reaction with SO₂ forms a solid calcium sulfite (CaSO₃) slurry. Other common reagents include calcium hydroxide and magnesium hydroxide. In many cases the calcium sulfite initially formed in the scrubber is further oxidized to form calcium sulfate (CaSO₄), or gypsum. Synthetic gypsum is used in a variety of commercially useful products such as wallboard or soil amendments, or it may be land filled as a non-hazardous material.

Other undesirable pollutants that must also be removed from flue gases are heavy metals and selenium. A particular heavy metal of concern is mercury. One advantage of the scrubber technology is that the calcium sulfite/sulfate slurry turns out to be very effective in the capture of at least one type of gaseous mercury found in the flue gas.

Gas phase mercury typically occurs in combustion gas in one of two forms, elemental or metallic mercury, Hg⁰, and oxidized mercury or Hg⁺². It is the oxidized form of mercury that is more readily solubilized in the slurry that forms within a scrubber. The majority of the dissolved oxidized mercury ends up associated with what is referred to as an iron rich fines, or clay like fraction of the scrubber solids, and therefore is not emitted from the plant stack.

Mercury emission control through the capture of Hg⁺² within the scrubber is generally effective; however it is not without problems. One particularly difficult problem results from a chemical reaction called re-emission. In the re-emission process oxidized mercury dissolved in the scrubber slurry is re-reduced to elemental mercury or Hg⁰ and then out gassed from the scrubber. This phenomenon is readily observed when the concentration of Hg⁰ at the scrubber exit is greater than the concentration at the entrance. Mercury re-emission is typically expressed as a percent and calculated as follows:

$$\frac{{Hg}_{out}^{0} - {Hg}_{in}^{0}}{{Hg}_{in}^{+ 2}} = re \text{-} emission$$

A mercury re-emission range from on the order of 15% to in excess of 50% in many cases represents a serious impediment to a company's ability to meet current or anticipated reductions in mercury emissions.

An additional problem is related to the strength of the bond between Hg⁺² and the solid components within the scrubber slurry to which it is bound. In particular, it has been noted by the wallboard manufacturing industry that the temperatures used in drying and calcining gypsum for wallboard production results in significant releases of mercury as a result of thermal decomposition of the mercury/scrubber solid complex. A further issue related to mercury-gypsum bonding strength weakness is the leaching of mercury from the scrubber solid when that material is used for agriculture, or simply goes directly to land fill.

One solution to the problems of mercury re-emission and thermal decomposition or leaching is to capture and sequester mercury in the scrubber in a much more insoluble and thermally stable chemical form; in particular in the form of mercury sulfide (HgS). Mercury sulfide is thermally stable and chemically inert. As a result of its chemical inertness, it will not re-reduce to elemental mercury and so not participate in the re-emission reaction. As a result of its thermal stability, it will not be released during the wall board manufacturing process.

One technology for the capture of both oxidized and elemental mercury within a scrubber is described in U.S. Pat. No. 7,407,602. In this technology, an earth metal sulfide and a phosphate buffering agent are added to the scrubber slurry as an aerosol—or added and subsequently aerosolized—in such a way that both Hg⁺² and some fraction of Hg⁰ are reacted to form an insoluble and thermally stable β-mercury sulfide.

U.S. Pat. No. 6,503,470 discloses another process for removing mercury in the form of mercury sulfide in scrubbers. In particular, sodium hydrogen sulfide or NaSH is used to react with and sequester mercury as mercury sulfide.

Heavy metal removal from combustion gases such as flue gas still remains a problem. Additional methods of removing these heavy metals are, therefore, sought.

### SUMMARY OF THE INVENTION

This invention provides a process and chemical composition effective in removing heavy metal from combustion gas. The process and chemical composition are particularly effective in removing undesirable metal from combustion gases that are formed from the combustion of coal.

According to one aspect of this invention, there is provided a process for removing a heavy metal from a combustion gas. The process includes providing a combustion gas containing a heavy metal that is desired to be removed from the combustion gas. The combustion gas is contacted with an aqueous composition of at least one alkali metal sulfide, and at least one alkali metal or alkaline earth metal buffer to remove at least a majority of the heavy metal from the combustion gas.

In one embodiment, the combustion gas is formed from the combustion of coal. Preferably, the heavy metal that is desired to be removed is selected from the group consisting of zinc, cadmium and mercury. More preferably, the heavy metal that is desired to be removed is mercury.

In one embodiment, the at least one alkali metal sulfide of the aqueous composition is a compound comprising a S⁻² ion or a HS⁻ ion. Preferably, the at least one alkali metal sulfide is a mono-sulfide or a poly-sulfide.

In another embodiment, the alkali metal of the at least one alkali metal sulfide is sodium or potassium. Preferably, the alkali metal of the at least one alkali metal sulfide is sodium.

The at least one alkali metal or alkaline earth metal buffer of the aqueous composition is preferably a carbonate, hydroxide or phosphate compound that includes at least one element selected from the Group 1 and Group 2 elements of the periodic table. In one embodiment, the at least one alkali metal or alkaline earth metal buffer is a carbonate, hydroxide or phosphate compound that includes sodium or potassium. In another, the at least one alkali metal or alkaline earth metal buffer is a carbonate, hydroxide or phosphate compound that includes magnesium or calcium.

In another embodiment of the invention, the aqueous composition comprises an alkaline earth metal buffer and a phosphate buffer different from the alkaline earth metal buffer. Preferably, the phosphate buffer contains one or more of magnesium and calcium.

In yet another embodiment of the invention, the aqueous composition comprises sodium hydrosulfide, calcium carbonate and triple superphosphate.

### DETAILED DESCRIPTION OF THE INVENTION

The process of this invention is particularly effective at removing heavy metal from a combustion gas. The process is particularly suited to removal of at least one of the d block metals of the periodic table. Metals that can be most effectively removed from the combustion gas are the group 12 metals, zinc, cadmium and mercury, particularly mercury.

The combustion gas that is to be treated or contacted according to this invention is a gas that is a product of a combustion reaction and that contains at least one heavy metal. Typical combustion gases are those that form from the combustion of fossil fuels, biomass or waste materials. Particular examples of combustion gases that can be effectively contacted or treated according to this invention further include gases that are formed from the combustion of coal (e.g., bituminous or lignite coal).

The invention is particularly effective on a combustion gas that contains heavy metal that is to be removed at a concentration of at least 0.1 μg/m³, preferably from 0.1 to 5,000 μg/m³. More commonly, the combustion gas that is contacted or treated according to this invention contains heavy metal that is to be removed at a concentration of from 1 to 1,000 μg/m³, and more typically from 2 to 100 μg/m³. This concentration is on a basis of the particular heavy metal that is the focus of removal, rather than total heavy metal content. For example, when one of the group 12 metals, e.g., mercury, is the focal point for measuring removal, then the combustion gas will be monitored according to that particular metal for concentration measurement.

A substantial amount of heavy metal present in the combustion gas that is to be contacted or treated according to this invention is removed. At least of a majority (i.e., ≧50%) of the heavy metal is removed from the non-treated combustion gas. Preferably, at least 75% of the heavy metal is removed, and more preferably at least 90%.

To effectively remove heavy metal from the combustion gas, the combustion gas is contacted or treated with an aqueous composition to which has been added components effective in removing the heavy metal. The aqueous composition includes an additive component of at least one alkali metal sulfide. The alkali metal is at least one metal selected from the Group 1 elements of the periodic table. Preferably, the alkali metal is sodium or potassium, more preferably sodium.

The alkali metal sulfide can be a compound comprising a S⁻² ion or a HS⁻ ion. In the case where the compound includes a S⁻² ion, the sulfide can be a mono-sulfide or a poly-sulfide. In one embodiment, the compound is Mₓ-S_{y}, with M being a metal selected from the Group 1 elements of the periodic table, x being an integer of from 1 to 10, and y being, independently, an integer of from 1 to 10. Preferably, the alkali metal is sodium or potassium, more preferably sodium. Preferably, x is an integer of from 1 to 4, more preferably x is 2. In one embodiment, y is 1. In another y is at least 2. Such examples include, but are not limited to, Na₂S₅, Na₂S₇, and Na₂S₉.

In one embodiment, the alkali metal sulfide is a compound that is a mono-sulfide. Preferably, the compound is sodium sulfide or potassium sulfide. A mixture of compounds can also be effectively used.

In one embodiment, the alkali metal sulfide is a compound that comprises a HS⁻ ion. This compound can also be referred to as a hydrosulfide. Preferably, the compound is sodium hydrosulfide (also referred to as sodium hydrogen sulfide) or potassium hydrosulfide (also referred to as potassium hydrogen sulfide). A mixture of compounds can also be effectively used.

The alkali metal sulfide should be included in or added to the aqueous composition that is used to contact or treat the combustion gas in a quantity that is suitable to remove at least a majority of the heavy metal that is desired to be removed. Preferably, the aqueous composition includes the alkali metal sulfide at a concentration of at least 10 wt %, based on total weight of the aqueous composition. More preferably, the aqueous composition includes the alkali metal sulfide at a concentration of from 10 wt % to 50 wt %, still more preferably from 12 wt % to 40 wt %, and most preferably from 15 wt % to 30 wt %, based on total weight of the aqueous composition. Where the alkali metal sulfide is added to the aqueous composition, the amount indicated herein refers to the amount of alkali metal sulfide that is added to the aqueous composition on a total weight basis.

The aqueous composition includes at least one alkali metal or alkaline earth metal buffer. Preferably, the buffer is effective at buffering the aqueous composition at a pH of from 5 to 11, more preferably from 5 to 7, and most preferably from 5.5 to 6.5.

The alkali metal or alkaline earth metal buffer should be included in or added to the aqueous composition in a quantity that is sufficient to provide buffering within the desired pH range. In general, the alkali metal or alkaline earth metal buffer should be included in or added to the aqueous composition in a quantity of from 20 wt % to 70 wt %, preferably from 30 wt % to 60 wt %, more preferably from 50 wt % to 55 wt %, based on total weight of the aqueous composition. Where the alkali metal or alkaline earth metal buffer is added to the aqueous composition, the amount indicated herein refers to the amount of alkali metal or alkaline earth metal buffer that is added to the aqueous composition on a total weight basis.

In one embodiment, the aqueous composition preferably includes the alkali metal sulfide and at least one alkali metal or alkaline earth metal buffer at a ratio of alkali metal sulfide to the at least one alkali metal or alkaline earth metal buffer of from 0.05:1 to 3:1. More preferably, the aqueous composition preferably includes the alkali metal sulfide and at least one alkali metal or alkaline earth metal buffer at a ratio of alkali metal sulfide to the at least one alkali metal or alkaline earth metal buffer of from 0.1:1 to 2:1, and most preferably from 0.2:1 to 1:1.

In a particular embodiment of the invention, the alkali metal or alkaline earth metal buffer is a carbonate, hydroxide or phosphate compound that includes at least one element selected from the Group 1 and Group 2 elements of the periodic table. In one embodiment, the composition includes at least one Group 1 element, preferably sodium or potassium. In another embodiment, the composition includes at least one Group 2 element, preferably magnesium or calcium.

Examples of alkali metal buffer include, but are not limited to sodium carbonate, sodium hydroxide, sodium phosphate, potassium carbonate, potassium hydroxide and potassium phosphate.

Examples of alkaline earth metal buffer include, but are not limited to, calcium carbonate, calcium hydroxide, calcium phosphate, magnesium carbonate, magnesium hydroxide, magnesium phosphate, mixed calcium-magnesium carbonates, mixed calcium-magnesium hydroxides, mixed calcium-magnesium phosphates, triple superphosphate, apatite, and mixtures thereof. Triple superphosphate (also known as trisuperphosphate, TSP, and superphosphate) is predominately monocalcium phosphate hydrate (CaH₂PO₄)₂.H₂O) (CAS No. 65996-95-4)).

In another embodiment of the invention, the aqueous composition is formed of an alkali metal sulfide and at least one alkaline earth metal buffer. Preferably, the alkali metal sulfide is one or more of sodium sulfide, potassium sulfide, sodium hydrosulfide and potassium hydrosulfide. The alkaline earth metal buffer is preferably one or more of calcium carbonate, calcium hydroxide, calcium phosphate, magnesium carbonate, magnesium hydroxide, magnesium phosphate, mixed calcium-magnesium carbonates, mixed calcium-magnesium hydroxides, mixed calcium-magnesium phosphates, triple superphosphate and apatite.

The aqueous composition can also include additional components as desired. In one embodiment, the aqueous composition includes a phosphate buffer in addition to the alkaline earth metal buffer, wherein the phosphate buffer is different from the alkaline earth metal buffer. Preferably, the phosphate buffer contains one or more of magnesium and calcium. Examples of phosphate buffer containing one or more of magnesium and calcium include, but are not limited to, magnesium phosphate, calcium phosphate, mixed calcium-magnesium phosphates, triple superphosphate and apatite.

When a separate phosphate buffer is used in addition to the alkaline earth metal buffer, the phosphate buffer is preferably included in or added to the aqueous composition in a quantity of from 20 wt % to 70 wt %, preferably from 30 wt % to 60 wt %, more preferably from 50 wt % to 55 wt %, based on total weight of the aqueous composition. Where the separate phosphate buffer is added to the aqueous composition, the amount indicated herein refers to the amount of phosphate buffer that is added to the aqueous composition on a total weight basis.

In another particular embodiment of the invention, the aqueous composition is an aqueous composition of alkali metal sulfide, preferably one or more of sodium sulfide, potassium sulfide, sodium hydrosulfide, and potassium hydrosulfide; alkaline earth metal buffer, preferably one or more of calcium carbonate, calcium hydroxide, magnesium carbonate, magnesium hydroxide, mixed calcium-magnesium carbonates, mixed calcium-magnesium hydroxides, triple superphosphate, apatite; and phosphate buffer different from the alkaline earth metal buffer, preferably one or more of magnesium phosphate, calcium phosphate, mixed calcium-magnesium phosphates, triple superphosphate and apatite. One particular example of an aqueous composition is an aqueous composition of sodium hydrosulfide, calcium carbonate and triple superphosphate.

The aqueous composition of this invention can be contacted with the combustion gas containing the heavy metal that is desired to be removed by any means appropriate to provide the proper contact. Preferably, the aqueous composition is, at least in the initial state of contact, primarily in liquid form. Wet or dry type scrubbing systems can be used for this type of contact.

In one embodiment, the scrubbing system includes at least one nozzle through which the aqueous composition is sprayed to contact the combustion gas and treat the gas for removal of the heavy metal that is desired to be removed. In another embodiment, the scrubbing system is a bubbling bed type design in which the combustion gas is bubbled through a liquid layer of the aqueous composition. The principles and modes of operation of this invention have been described above with reference to various exemplary and preferred embodiments. As understood by those of skill in the art, the overall invention, as defined by the claims, encompasses other preferred embodiments not specifically enumerated herein.

1. A process for removing a heavy metal from a combustion gas, comprising:
providing a combustion gas containing a heavy metal that is desired to be removed from the combustion gas; and
contacting the combustion gas with an aqueous composition of at least one alkali metal sulfide, and at least one alkali metal or alkaline earth metal buffer to remove at least a majority of the heavy metal from the combustion gas.

2. The process of claim 1, wherein the combustion gas is formed from the combustion of coal.

3. The process of claim 1, wherein the heavy metal that is desired to be removed is selected from the group consisting of zinc, cadmium and mercury.

4. The process of claim 3, wherein the heavy metal that is desired to be removed is mercury.

5. The process of claim 1, wherein the at least one alkali metal sulfide is a compound comprising a S⁻² ion or a HS⁻ ion.

6. The process of claim 1, wherein the at least one alkali metal sulfide is a mono-sulfide or a poly-sulfide.

7. The process of claim 1, wherein the alkali metal of the at least one alkali metal sulfide is sodium or potassium.

8. The process of claim 7, wherein the alkali metal of the at least one alkali metal sulfide is sodium.

9. The process of claim 1, wherein the at least one alkali metal or alkaline earth metal buffer is a carbonate, hydroxide or phosphate compound that includes at least one element selected from the Group 1 and Group 2 elements of the periodic table.

10. The process of claim 1, wherein the at least one alkali metal or alkaline earth metal buffer is a carbonate, hydroxide or phosphate compound that includes sodium or potassium.

11. The process of claim 1, wherein the at least one alkali metal or alkaline earth metal buffer is a carbonate, hydroxide or phosphate compound that includes magnesium or calcium.

12. The process of claim 1, wherein the aqueous composition comprises an alkaline earth metal buffer and a phosphate buffer different from the alkaline earth metal buffer.

13. The process of claim 12, wherein the phosphate buffer contains one or more of magnesium and calcium.

14. The process of claim 14, wherein the aqueous composition comprises sodium hydrosulfide, calcium carbonate and triple superphosphate.

15. An aqueous composition effective in removing heavy metal from combustion gas, comprising:
at least one alkali metal selected from the Group 1 elements of the periodic table in an amount effective for removing the heavy metal from the combustion gas; and
at least one alkali metal buffer or alkaline earth metal buffer at a concentration effective at buffering the aqueous composition at a pH of from 5 to 11.

16. The aqueous composition of claim 15, wherein the at least one alkali metal sulfide is a compound comprising a S⁻² ion or a HS⁻ ion.

17. The aqueous composition of claim 16, wherein the alkali metal of the at least one alkali metal sulfide is sodium or potassium.

18. The aqueous composition of claim 15, wherein the at least one alkali metal or alkaline earth metal buffer is a carbonate, hydroxide or phosphate compound that includes at least one element selected from the Group 1 and Group 2 elements of the periodic table.

19. The aqueous composition of claim 15, wherein the at least one alkali metal or alkaline earth metal buffer is a carbonate, hydroxide or phosphate compound that includes magnesium or calcium.

20. The aqueous composition of claim 15, wherein the aqueous composition comprises an alkaline earth metal buffer and a phosphate buffer different from the alkaline earth metal buffer.
